(19) United States
(12) Patent Application Publication
(10) Pub. No.: US 2005/0275281 A1
(43) Pub. Date: Dec. 15, 2005

(54) Modular braking system

(76) Inventor: Robert David Prescott, Solihull (GB)

Correspondence Address: ST. ONGE STEWARD JOHNSTON & REENS, LLC, 986 BEDFORD STREET, STAMFORD, CT, 06905-5619, US

(21) Appl. No.: 11/128,035

(22) Filed: May 12, 2005

Related U.S. Application Data
(60) Provisional application No. 60/570,586, filed on May 13, 2004.

(51) Int. Cl. B60T 8/42

(52) U.S. Cl. 303/119.3

(57) ABSTRACT

A modular brake system, such as is used in ABS and EBS that allows for exchangeability of the various brake parts including the modulator, actuator and brake assembly; the modulator being detachably connectable and located adjacent to or directly on the actuator. An ECU further controls the brake system and is provided with redundant control line inputs. The control line inputs, both primary and back-up, are provided as electrical lines extending from the control device to the controller.

### CROSS-REFERENCE

This application claims the benefit of the filing date of U.S. Provisional Patent Application Ser. No. 60/570,586 filed May 13, 2004.

### FIELD OF THE INVENTION

The system relates to a brake system for use on vehicles, and more particularly to a modular brake system for use in tractor-trailer combinations that provides for redundant control input signals to provide greater reliability without compromising system performance.

### BACKGROUND OF THE INVENTION

The use of Anti-lock Braking Systems (ABS) and Electronic Braking Systems (EBS) has become increasingly popular on vehicle. These types of system provide advantages over conventional braking systems including improving vehicle control during braking and reducing stopping distances on, for example, slippery road surfaces by limiting or minimizing wheel slip and lockup.

While ABS and EBS may be used on a wide variety of vehicles, tracker-trailer combinations present a unique set of braking challenges as opposed to the other vehicle categories. Typically, tracker-trailer combinations utilize air-actuated braking systems that include an actuator and a brake assembly. Relatively recent governmental regulations however, have mandated that tracker-trailer combinations further be provided with ABS to increase vehicle safety.

Typically, ABS includes a modulator valve to regulate, reduce and/or hold brake application pressure to a particular wheel. The modulator valve may be controlled by an Electronic Control Unit (ECU). However, the general practice in the industry has been to provide the modulator integral with other components. This approach disadvantageously limits the type of modulator that may be utilized in a particular braking system. This approach further limits the versatility of the system by limiting the type of actuator and brake components that may be utilized with one another. Therefore, even when newer and higher performance modulators, actuators or brake assemblies are offered, or even when it would be desirable to utilize an existing piece of equipment in place of, for example, the integrally formed modulator, these different and/or improved pieces of equipment cannot be utilized without changing out the entire or at least a relatively large portion of the brake system. This lack of versatility of existing brake systems is highly undesirable.

Another problem facing current ABS and EBS systems is reliability. Current braking systems typically include a complex system of pneumatic and/or hydraulic controls. These types of controls are inherently subject to certain types of problems due to requiring a fluid medium. For example, if a leak in the line occurs, this may severely affect the functionality of the control system. Leaks may occur due to physical damage or due to wear of the system over time. Repair of these systems may be quite costly and time consuming. While it is contemplated that redundant control systems may provide for increased reliability, redundant pneumatic and/or hydraulic lines simply not cost effective and undesirably increase the complexity of the system.

Another problem with pneumatic and hydraulic systems is that typically they require greater space for installation. For example, pneumatic and hydraulic lines have a maximum bending radius that cannot be exceeded without damage to and severe impairment to proper functioning of the control system. Installation space in vehicles is at a premium however, especially in the cabin of a tracker-trailer combination where running pneumatic and hydraulic control lines is quite challenging. As a result, it is desirable to run as few control lines as possible to accomplish the desired control.

In order to improve system reliability, redundant control systems have been utilized in other types of control systems. However, this approach is simply impractical with pneumatic and/or hydraulic control lines located in vehicles as the cost involved with providing such back-up lines would be prohibitive. In addition, the additional space needed to provide the back-up lines is not available. Still further, the control scheme needed to switch between primary or back-up pneumatic or hydraulic lines would be exceedingly complex.

Alternatively, simplified back-up systems may be offered; however, any loss in functionality of the control system, even during use of any back-up system or equipment, is unacceptable.

Accordingly, what is needed is a brake system and method that allows for the use of various modulators with various actuators and brake assemblies.

It is also desired to provide a brake system and method that increases the brake system performance.

It is further desired to provide a brake system and method that provides increased reliability without adding significant costs or using significant additional space.

It is still further desired to provide a brake system and method that provides no reduction in functionality even during operation of any back-up system provided.

### SUMMARY OF THE INVENTION

Accordingly, these and other objectives are achieved in one embodiment of the present invention, by a vehicle brake system that includes a detachably removable modulator. Rather than providing the modulator integral with any other piece of equipment, the modulator is a self-contained, modular unit that may be freely attached to and detached from, for example, the actuator. In this manner, any type of modulator appropriate for the application may be utilized for the application. This allows for greater versatility, which is highly desirable. Depending upon the application, a particular modulator, actuator and/or brake assembly may be selected based on for example, the size of the unit, cost considerations, and/or performance considerations. The system may also be designed and parts selected for a particular use or application. In any event, increased versatility allows for greater selection among the various parts.

It is contemplated that the selected modulator may be detachably connectable to the actuator, either directly onto the housing of the actuator or by means of an attachment member, via a mechanical connection such as for example; bolts, pins, screws, tabs, clamps, etc., which allows for selection and attachment of any one of a plurality of various modulators.

In another advantageous embodiment of the present invention, a controller is provided for controlling the modulator. The controller may be for example, an ECU that receives various control inputs and generates various control outputs. It is contemplated that the control inputs may be provided via electrical lines rather than pneumatic or hydraulic line inputs. Use of electrical lines provides a number of distinct advantages over pneumatic or hydraulic lines. For instance, electrical lines are relatively inexpensive to install and they take up very little space. Electrical lines are typically not subject to the stringent bending requirements associated with pneumatic or hydraulic lines. These benefits make it cost-effective to provide redundant control lines from various parts of the vehicle to the controller. In addition, the switching circuitry that must be provided to allow for switching from a primary electrical signal line to a back-up line does not significantly add to the complexity or cost to the system. The overall result is a system with significantly higher reliability that is not significantly more expensive and that doesn't use significantly more space.

Use of electrical lines to provide control inputs to the ECU also simplifies the system because there are not pneumatic or hydraulic control signals that have to be translated into an electronic format by the ECU. The entire system is provided as an electronic brake control system such that substantially all of the control is in electrical and electronic format.

The provision of redundant electrical lines further allows for substantially no decrease in control system functions upon activation of the back-up system as electrical lines are entirely redundant.

In one advantageous embodiment of the present invention, a vehicle brake system is provided comprising, a brake assembly and an actuator that is fluidly coupled to and provided for actuating the brake assembly. The system further comprises a modulator fluidly coupled between the actuator and a source of pressurized fluid, with the modulator modulating the flow of pressurized fluid to the actuator. The system is still further provided such that the modulator is a modular self-contained unit apart from the actuator, the modulator being detachably connectable to the actuator.

In another advantageous embodiment of the present invention, a vehicle brake system is provided comprising, a source of pressurized fluid, a modulator valve fluidly coupled to the source of pressurized fluid, and an actuator fluidly coupled to the modulator valve. The system further comprises, a brake assembly fluidly coupled to the actuator, and a controller electrically connected to the modulator valve. The system is provided such that the modulator is provided as a modular self-contained unit apart from the actuator, the modulator being detachably connectable to the actuator. The system still further comprises, a first control input electrically connected to the controller, and a second control input electrically connected to the controller, the second control input provided as a back-up control input for the first control input.

In still another advantageous embodiment of the present invention, a method of braking a vehicle is provided comprising the steps of, selecting one of a plurality of modulators, each of the plurality of modulators having different characteristics and detachably coupling the selected modulator to an actuator. The method further comprises the steps of, supplying pressurized fluid to the modulator and operating the modulator to selectively apply pressurized fluid to the actuator to actuate a brake based upon a control input.

Other objects of the invention and its particular features and advantages will become more apparent from consideration of the following drawings and accompanying detailed description.

### BRIEF DESCRIPTION OF THE DRAWINGS

FIG. 1 is a block diagram of one advantageous embodiment of the present invention.

FIG. 1A is a block diagram according to FIG. 1 of an advantageous embodiment of the present invention.

FIG. 2 is a block diagram according to FIG. 1 of another advantageous embodiment of the present invention.

FIG. 3 is a block diagram according to FIG. 1 of still another advantageous embodiment of the present invention.

FIG. 4 is a block diagram according to FIG. 1 illustrating the control signals.

FIG. 5 is a block diagram according to FIG. 4 illustrating redundant control signals.

FIG. 6 is a schematic view illustrating an electrically controlled and/or actuated braking system.

### DETAILED DESCRIPTION OF THE DRAWINGS

Referring now to the drawings, wherein like reference numerals designate corresponding structure throughout the views.

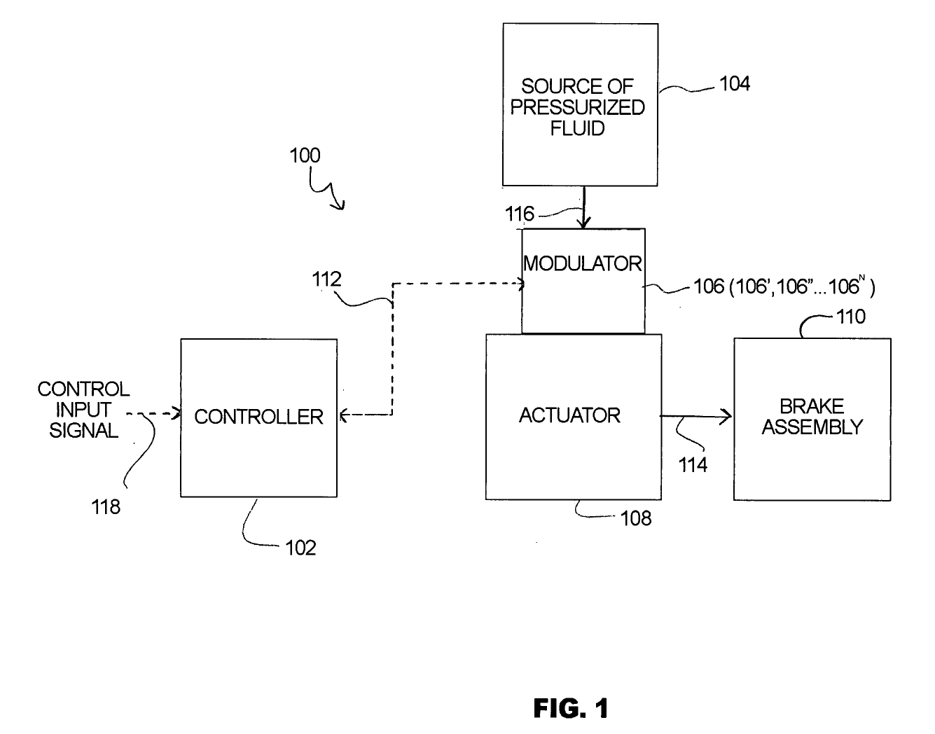

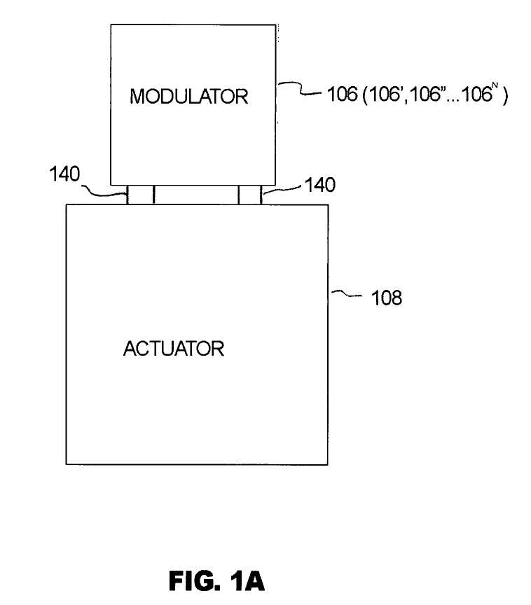

FIG. 1 illustrates braking system 100 in block diagram format. Braking system 100 may in one advantageous embodiment comprise controller 102, source of pressurized fluid 104, modulator 106, actuator 108 and brake assembly 110.

As previously described, controller 102 may comprise an ECU that is capable of receiving control input signal 1 18. Controller 102 is also coupled to and controls modulator 106 via control line 112. In one advantageous embodiment, control input signal 118 comprises and electrical signal representative of a control occurrence, such as for example but not limited to, a braking action by the driver. Control input signal 118 is further illustrated as a single line, however, it is contemplated that control input signal may comprise many and/or a variety of signals. In one advantageous embodiment, controller 102 is a local controller that takes care of local braking control such as, service brake function, park braking function and sensor node (wear, force, torque, wheel spin, temperature, etc.).

Control input signal may further comprise one or more electrical lines that extend from a control device (not shown) such as for instance, a brake foot pedal to controller 102. As previously discussed, electrical lines provide distinct advantages over pneumatic and/or hydraulic lines in that they are more reliable, cost less to install, and require less space for installation.

It is contemplated that controller 102 may further be located in the vicinity of the wheel (not shown), or in the alternative, it may be located remotely from the wheel (not shown) location.

Source of pressurized fluid 104 is in fluid communication with modulator 106 via fluid line 116. Source of pressurized fluid 104 may comprise any suitable fluid source for the application including, for example but not limited to, clean and dried air, and/or a hydraulic fluid. In the case that the fluid is clean and dried air, an air compressor (not shown), air drier (not shown) and air filter (not shown) as is commonly employed in air brake systems would also be utilized to provide source of pressurized fluid 104 with pressurized air.

Modulator 106 is further identified by numbers (106′,106″ . . . 106ⁿ), which is provided to indicate that any number of different modulators may freely be substituted for modulator 106. It is contemplated that modulator 106 is fluidly coupled to actuator 108 via a fluid line (not shown) to selectively provide pressurized fluid to actuator 108. In one advantageous embodiment, modulator 106 is directly attached to the housing of actuator 108. Attachment may be accomplished by bolting modulator 106 directly onto the exterior housing of actuator 108. Positioning modulator 106 in such close proximity to actuator 108 provides the advantage that actuator 108 will be more responsive to the modulation of modulator 106 during, for instance, a braking action because the distance between the two units has been decreased. Actuator 108 may be provided with bolt holes (not shown) in various locations to accommodate various sized modulators, which may be selected according to various criteria including for example; size, cost, performance, etc.

Alternatively, modulator 106 could be attached to actuator 108 through a coupling or attachment member such as a nipple or stand-off members. Accordingly, modulator 106 is “detachably connectable” to actuator 108, meaning that modulator 106 may be selected from a variety of modulators that can be freely connected to and disconnected from actuator 108, whether the connection is directly on the housing of actuator 108 or through an attachment member 140 (FIG. 1A). In any case, modulator 106 is positioned in close proximity to actuator 108 and may be secured thereto by any mechanical means such as for example; bolts, pins, screws, tabs, clamps, etc.

Actuator 108 is coupled to brake assembly 110 as shown at 114 to provide control actuation of brake assembly 1 10. It is further contemplated in one advantageous embodiment, that actuator 108 and brake assembly 110 are also modular components that may be freely selected and combined according to the application. This modular approach provides greater versatility for brake system 100, which is highly desirable. For example, depending upon the application a particular modulator, actuator and/or brake assembly may be selected based on cost considerations and/or performance considerations. Each unit can be installed individually and be preset to a particular desired vehicle setup.

Further, the brake assembly may comprise any type of brake system desired such as but not limited to, a drum brake or a disk brake as is commonly used on tractor-trailer combinations, and may further comprise, for example, an air brake or a hydraulic brake.

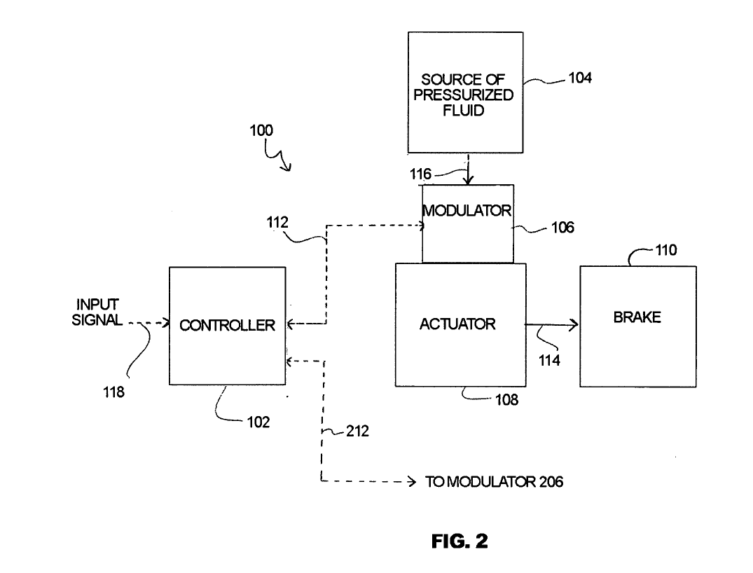

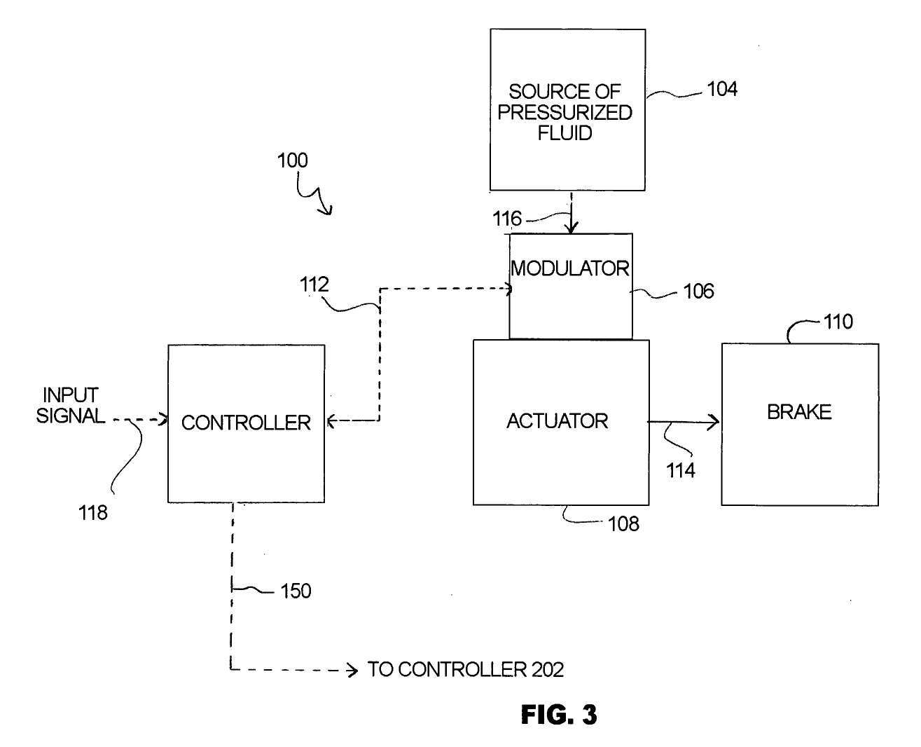

Referring now to FIG. 2, an alternative embodiment of FIG. 1 is illustrated. FIG. 2 is similar to FIG. 1 except line 212 is further illustrated extending between controller 102 and modulator 206. It is contemplated that controller 102 may controller multiple brake systems such as brake system 100 and at least one additional brake system. In this manner, controller 102, which may comprise an ECU, may control for example, both front wheels of the vehicle or both rear wheels of the vehicle. In this case, an additional controller 202 (FIG. 3) would be provided such that controller 102 and controller 202 can communicate with each other via a communication line 150 in a network arrangement or the like.

Alternatively, it is contemplated that only controller 102 is provided and controls each and every wheel of the vehicle. Still further, a controller may be provided for each and every wheel in which case the various controllers may be connected to each other via a network connection. One advantage of providing a controller at each wheel is that response and decision time is reduced. It is still further contemplated that the controllers may be provided as a modular unit such that different controllers may be selected and installed based upon the particular application providing greater versatility.

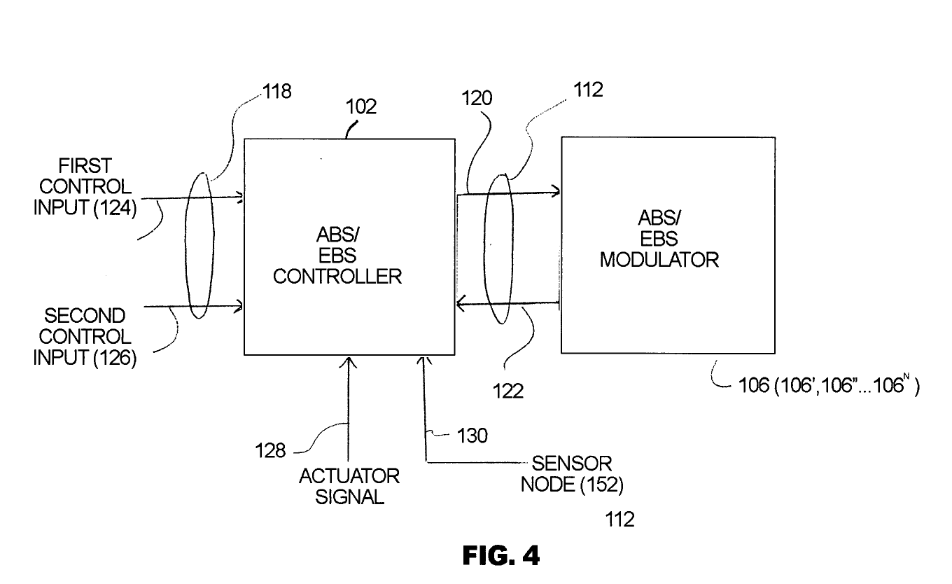

Referring now to FIG. 4, controller 102 and modulator 106 are shown in greater detail. Control input signal 118 is provided to controller 102, which may comprise an ECU for ABS and/or EBS brake systems. Control input signal 118 comprises both first control input 124 and second control input 126. First control input 124 may comprise any type of control input for activating brake system 100, such as for example but not limited to, a signal from a foot brake in the cabin of the vehicle. First control input 124, once received is processed by controller 102, which in turn generates a corresponding output signal 120 that is sent to modulator 106 for controlling the actuator 108.

A feedback signal 122 may further be provided to controller 102 supplying controller 102 with information relating to modulator 106. An additional signal 128 may be supplied to controller 102 from actuator 108 to provide controller 102 with information relating to actuator 108. Also provided is input 130, which may comprise for example but is not limited to a signal from a sensor node 152 for monitoring: wear, force, torque, wheel spin, temperature, etc.

Second control input 126 may be a redundant communication line of first control input 124. In this manner, if first control input 124 becomes damaged or inoperative, overall system performance will not be compromised. It is contemplated that both first and second control inputs 124, 126 are both electrical lines, which do not suffer from the inherent problems previously discussed herein and run from the cabin (not shown) of the vehicle (not shown) to controller 102.

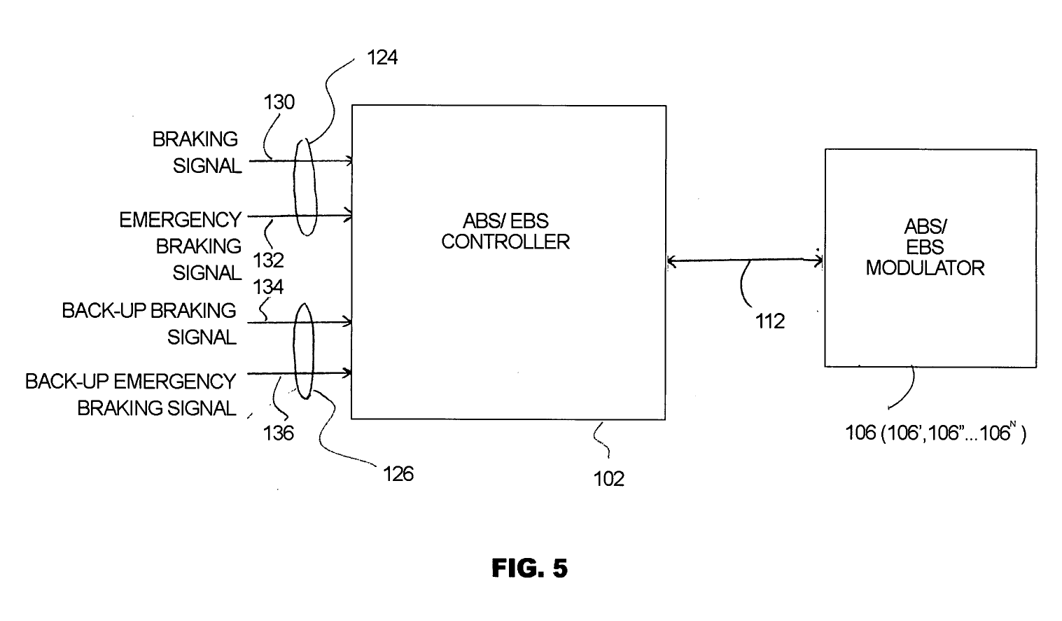

FIG. 5 shows first and second control inputs 124, 126 in greater detail. For example, first control input 124 may comprise in one advantageous embodiment, braking signal 130 and emergency braking signal 132, while second control input 126 may comprise back-up braking signal 134 and back-up emergency braking signal 136. This illustration is not meant to be exhaustive as many different types of control input signals may advantageously be provided to controller 102 that may affect brake system 100.

Again, a full back-up electrical communication and/or control line may be provided such that in the event there is a problem with the primary communication and/or control line, there will be no compromise in system performance.

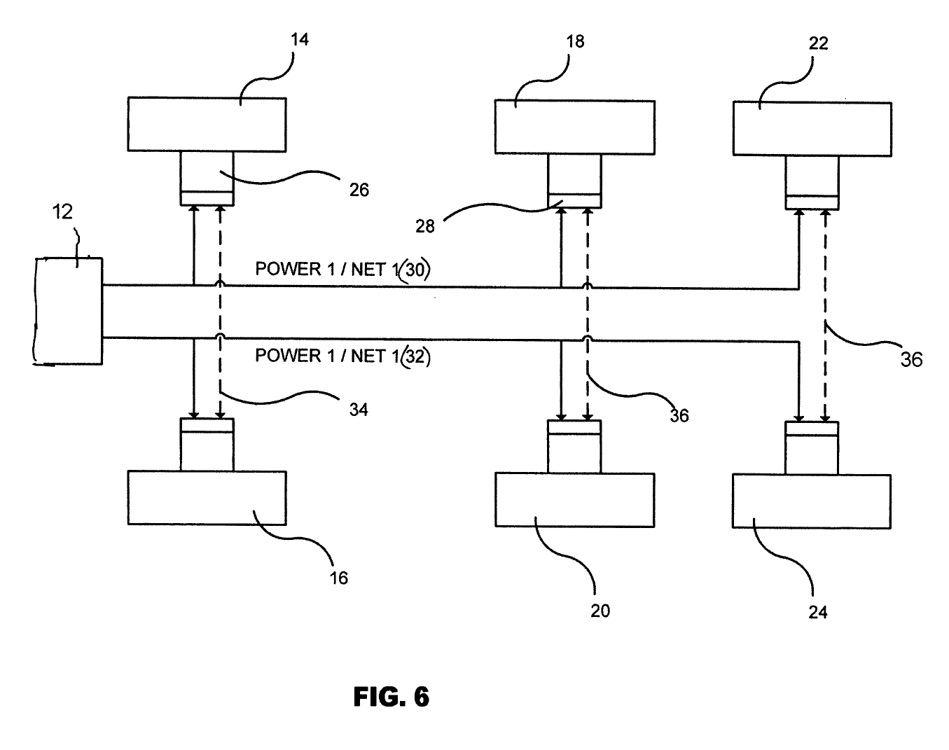

FIG. 6 illustrates still another embodiment of the invention illustrating advantageous embodiment for an electrically controlled and/or actuated braking system 10. Braking system 10 includes at least one control unit/power supply 12 which generates control signals and electrical power and/or stores electrical power. Braking system 10 also includes a plurality of brake components 14,16, 18, 20, 22, 24. While six brake components 14, 16,18, 20, 22, 24 are shown in FIG. 6, it should be understood that braking system 10 may include a greater or lesser number of brake components.

Each of brake components 14, 16, 18, 20, 22, 24 operates on electrical power generated and/or stored by and is responsive to control signals generated by control unit/power supply or supplies 12. More particularly, each of brake components 14,16, 18, 20, 22, 24 includes a brake actuator 26 incorporating an electronic control unit 28 which electronic control unit 28 causes brake actuator 26 to operate in response to control signals. Electronic control units 28 are supplied electrical power by control unit/power supply or supplies 12. Brake actuators 26 may comprise electromechanical brake actuators which are also supplied electrical power by control unit/power supply or supplies 12. Alternately, brake actuators 26 may be actuated by hydraulic power, pneumatic power, combinations of these, and/or by any other appropriate non-electrical power, in which case, it is not necessary to supply electrical power to brake actuators 26.

Braking system 10 includes at least two control/power supply networks for transmitting control signals and electrical power from control unit/power supply or supplies 12 to each of brake components 14, 16,18, 20, 22, 24, with some of brake components 14,16, 18, 20, 22, 24 being electrically connected to control unit/power supply or supplies 12 via one control/power supply network and others of brake components 14,16, 18, 20, 22, 24 being electrically connected to control unit/power supply or supplies 12 via another or other control/power supply network(s). Preferably, each one of each pair of brake components is connected to a different control/power supply network.

In braking system 10 shown in FIG. 6, two control/power supply networks 30, 32 are provided. First control/power supply network 30 electrically connects control unit/power supply or supplies 12 with first brake component 14, third brake component 18 and fifth brake component 22 (i.e., one of each pair of brake components). First control/power supply network 30 is adapted to transmit control signals/electrical power from control unit/power supply or supplies 12 to first brake component 14, third brake component 18 and fifth brake component 22. Second control/power supply network 32 electrically connects control unit/power supply or supplies 12 with second brake component 16, fourth brake component 20 and sixth brake component 24 (i.e., the other one of each pair of brake components not electrically connected to first power supply network 30). Second control/power supply network 32 is adapted to transmit electrical power from control unit/power supply or supplies 12 to second brake component 16, fourth brake component 20 and sixth brake component 24.

It is desirable that no brake component is directly electrically connected to both of first control/power supply network 30 and second control/power supply network 32. This is true so as to reduce the likelihood that an external catastrophic event, such as a tire explosion, in the vicinity of one of the brake components cuts the network cabling and/or causes a short-circuit in both control/power supply networks 30, 32, thereby causing the entire brake system 10 to fail.

Brake system 10 also includes auxiliary control/power supply links between each of the pairs of brake components, which auxiliary control/power supply links are activatable to electrically connect the pairs of brake components when a failure occurs in one of the control/power supply networks 30, 32, as described in more detail below. The auxiliary control/power supply links are adapted to transmit control signals/electrical power between each of the brake components forming each pair of brake components when such a failure occurs. In the embodiment shown in FIG. 6, three such auxiliary control/power supply links 34, 36, 38 are shown. First auxiliary control/power supply link 34 electrically connects first brake component 14 and second brake component 16, second auxiliary control/power supply link 36 electrically connects third brake component 18 and fourth brake component 20, and third auxiliary control/power supply link 38 electrically connects fifth brake component 22 and sixth brake component 24.

It should be recognized that for system 10 to properly function, control signals and enough electrical power for all brake components 14, 16, 18, 20, 22, 24 may be transmitted over both control/power supply networks 30, 32, not just the control signals and an amount of electrical power sufficient to operate the brake components directly connected to each individual control/power supply network 30, 32. For example, although first brake component 14 is not directly connected to second control/power supply network 32, control signals and enough electrical power to operate first brake component 14 should be transmitted over second control/power supply network 32, so that in the event of a failure of first control/power supply network 30 (to which first brake component 14 is attached), control signals and electrical power may be transmitted to first brake component 14 through second control/power supply network 32 and second brake component 16 via first auxiliary control/power supply link 34. In an alternative design, a low power mode may be employed when the power supply capability is limited (i.e., when one control/power supply network is failing or shorted). Although such a mode may provide degraded dynamic performance, such would prevent complete system failure.

Although the invention has been described with reference to particular arrangements and formulations and the like, these are not intended to exhaust all possible arrangements or features, and indeed many other modifications and variations will be ascertainable to those of skill in the art.

1. A vehicle brake system comprising:
a brake assembly;
an actuator fluidly coupled to and actuating said brake assembly;
a modulator fluidly coupled between said actuator and a source of pressurized fluid, said modulator modulating the flow of pressurized fluid to said actuator, and
said modulator is provided as a modular self-contained unit apart from said actuator, said modulator being detachably connectable to said actuator.

2. The vehicle brake system of claim 1 wherein said modulator is positioned directly on a housing of said actuator.

3. The vehicle brake system of claim 1 wherein said modulator is connected to a housing of said actuator by an attachment member.

4. The vehicle brake system of claim 1 wherein said vehicle braking system is selected from the group consisting of: an Electronic Braking System (EBS), an Anti-lock Braking System (ABS), or combinations thereof.

5. The vehicle brake system of claim 1 further comprising a controller coupled to said modulator via a control line, said controller controlling said modulator.

6. The vehicle brake system of claim 5 wherein said controller is mounted in the vicinity of said brake system.

7. The vehicle brake system of claim 5 which is provided as a first vehicle brake system for braking front wheels of the vehicle and a second vehicle brake system, substantially identical to the first vehicle brake system, which is provided for braking rear wheels of the vehicle.

8. The vehicle brake system of claim 7 further comprising a network connection connecting the controller of the first vehicle braking system with the controller of the second vehicle brake system.

9. The vehicle brake system of claim 5 which is provided for each wheel of the vehicle and further comprising a network connection connecting each of said controllers for each wheel to each other.

10. The vehicle brake system of claim 5 wherein said control line comprises and electrical line.

11. The vehicle brake system of claim 5 further comprising a first control input to said controller.

12. The vehicle brake system of claim 11 wherein said control input consists of an electrical line.

13. The vehicle brake system of claim 12 wherein said electrical line extends from a cabin of the vehicle to said controller.

14. The vehicle brake system of claim 11 further comprising a second control input to said controller, said second control input comprising a back-up to said first control input.

15. The vehicle brake system of claim 14 wherein said second control input consists of a second electrical line that extends from a cabin of the vehicle to said controller.

16. A vehicle brake system comprising:
a source of pressurized fluid;
a modulator valve fluidly coupled to said source of pressurized fluid;
an actuator fluidly coupled to said modulator valve;
a brake assembly fluidly coupled to said actuator;
a controller electrically connected to said modulator valve;
said modulator provided as a modular self-contained unit apart from said actuator, said modulator being detachably connected to said actuator;
a first control input electrically connected to said controller; and
a second control input electrically connected to said controller, said second control input provided as a back-up control input for said first control input.

17. The vehicle brake system of claim 16 wherein said modulator is positioned directly on said actuator.

18. The vehicle brake system of claim 16 wherein said first and second control inputs consist of electrical lines.

19. A method of braking a vehicle comprising the steps of:
selecting one of a plurality of modulators, each of the plurality of modulators having different characteristics;
detachably coupling the selected modulator to an actuator;
supplying pressurized fluid to the modulator; and
operating the modulator to selectively apply pressurized fluid to the actuator to actuate a brake based upon a control input.

20. The method of claim 19 wherein the characteristics of the plurality of modulators is selected from the group consisting of: size, cost and/or performance.

21. The method of claim 19 wherein the control input is generated by a controller and comprises and electrical signal.

22. The method of claim 21 further comprising the steps of:
supplying a first electrical signal to the controller; and
supplying a back-up electrical signal to the controller;
wherein the control input is generated by the controller based on the first electrical signal or based on the back-up electrical signal in the event of a failure of the first electrical signal.
